(19) United States
(12) Patent Application Publication
(10) Pub. No.: US 2012/0170880 A1
(43) Pub. Date: Jul. 5, 2012

(54) FLUID DYNAMIC BEARING DEVICE

(75) Inventors: Fuyuki Ito, Kuwana-shi (JP); Kazuo Okamura, Kuwana-shi (JP); Fuminori Satoji, Kuwana-shi (JP)

(73) Assignee: NTN CORPORATION, Osaka-shi, Osaka (JP)

(21) Appl. No.: 13/395,217

(22) PCT Filed: Aug. 31, 2010
(86) PCT No.: PCT/JP2010/064759

§ 371 Date: Mar. 9, 2012

(30) Foreign Application Priority Data
Sep. 29, 2009 (JP) 2009-224603

(51) Int. Cl. F16C 32/06

(52) U.S. Cl. 384/114

(57) ABSTRACT

A density of a bearing sleeve made of a sintered metal is set within a range of from 80% to 95% with respect to a true density, and a Young's modulus of the bearing sleeve is set to be equal to or more than 70 GPa. When the density of the bearing sleeve is increased and also the Young's modulus thereof is set to be equal to or more than 70 GPa in this manner, dimensional variation of an inner peripheral surface of the bearing sleeve can be suppressed to be equal to or less than 0.5 μm when a shaft member having an outer diameter of from 2 mm to 4 mm is to be supported.

### TECHNICAL FIELD

The present invention relates to a fluid dynamic bearing device in which a shaft member is supported so as to be relatively rotatable by a dynamic pressure action of a fluid film in a radial bearing gap to be formed between an outer peripheral surface of the shaft member and an inner peripheral surface of a bearing sleeve. More particularly, the present invention relates to a fluid dynamic bearing device including a bearing sleeve made of a sintered metal.

### BACKGROUND ART

The fluid dynamic bearing device has high rotational accuracy and quietness, and hence is suitably used in a spindle motor for devices such as magnetic-disk drive devices for information apparatus (for example, HDD), optical-disc drive devices for CDs, DVDs, Blu-ray Discs, or the like, or magneto-optical-disk drive devices for MDs, MOs, or the like.

For example, Patent Literature 1 discloses a fluid dynamic bearing device including a bearing sleeve made of a sintered metal. When the bearing sleeve is made of a sintered metal, numerous pores formed inside the sintered metal are impregnated with a lubricating oil, and the lubricating oil impregnated in the inner pores seeps into a bearing gap between a shaft member and the bearing sleeve at the time of rotation of the shaft member. In this way, an ample amount of the lubricating oil is supplied into the bearing gap, and hence lubricity is enhanced.

### CITATION LIST

Patent Literature 1: JP 2006-112614 A

### SUMMARY OF INVENTION

### Technical Problem

A dimensional accuracy of an inner peripheral surface of the bearing sleeve leads directly to an accuracy of the radial bearing gap, and consequently, has a significant influence on radial supportability. In particular, with regard to a use for supporting a small-diameter shaft (an outer diameter of from 2 mm to 4 mm) of, for example, a disk drive device of an HDD, which is to be rotated at ultra-high speed, the dimensional accuracy of the inner peripheral surface of the bearing sleeve is an important factor.

However, even when the inner peripheral surface of the bearing sleeve is processed with a high accuracy, various factors may cause dimensional variation of the inner peripheral surface. For example, pressure to be applied to the bearing sleeve at the time of fixing the bearing sleeve to an inner peripheral surface of a housing may cause the dimensional variation of the inner peripheral surface of the bearing sleeve. In particular, in the above-mentioned case of supporting the small-diameter shaft to be rotated at ultra-high speed, even slight dimensional variation of the inner peripheral surface of the bearing sleeve has a considerable influence on bearing performance.

The present invention has been made to achieve an object of providing a fluid dynamic bearing device in which dimensional variation of the inner peripheral surface of the bearing sleeve is suppressed to provide excellent radial supportability.

### Solution to Problem

In order to achieve the above-mentioned object, a fluid dynamic bearing device according to the present invention includes: a shaft member having an outer diameter of from 2 mm to 4 mm; a bearing sleeve made of a sintered metal and having an inner periphery on which the shaft member is inserted; a housing having an inner peripheral surface to which the bearing sleeve is fixed; and a radial bearing portion for supporting the shaft member with a fluid film in a radial bearing gap to be formed between an outer peripheral surface of the shaft member and an inner peripheral surface of the bearing sleeve so that the shaft member is relatively rotatable, in which a density of the bearing sleeve falls within a range of from 80% to 95% with respect to a true density, and in which a Young's modulus of the bearing sleeve is equal to or more than 70 GPa.

Note that, the term “true density” means a density of a solid under a state in which inner pores are not formed. For example, the true density can be obtained by measuring an effective volumetric capacity of a sintered metal (capacity excluding those of the inner pores) by perfectly closing the inner pores through crushing or the like, and by dividing a mass of the sintered metal by the effective volumetric capacity. Alternatively, the true density can be obtained also based on a true density of a raw material of a sintered metal and formulation rates of other materials. The density of the bearing sleeve made of a sintered metal is expressed in ratio to the true density (percentage) as described above, and the same applies to the following description.

As described above, by increasing the density of the bearing sleeve made of a sintered metal, specifically, by setting a density of the sintered metal to be equal to or more than 80%, strength of the bearing sleeve can be enhanced, and hence the dimensional variation of the bearing sleeve can be suppressed.

In this case, high strength can be achieved by increasing the density of the bearing sleeve nearly to the true density. However, inner pores of the sintered metal having such an ultra-high density are closed, and hence cannot be impregnated with a lubricating oil. Therefore, the above-mentioned advantage of enhanced lubricity cannot be obtained. Further, in order to increase the density of the sintered metal nearly to the true density, it is necessary to markedly increase pressure at the time of compression-molding of a metal powder, which disadvantageously leads to an increase in processing cost. Thus, there is an upper limit to the density of the bearing sleeve. Specifically, it is necessary to set the density of the bearing sleeve to be equal to or less than 95%. In order to more reliably suppress the dimensional variation of the inner peripheral surface of the bearing sleeve within such a density range, the inventors of the present invention have focused on a Young's modulus of the bearing sleeve, and conducted research on a relationship between the Young's modulus and a dimensional variation amount of an inner diameter of the bearing sleeve. Specifically, research was conducted on a difference in dimensional variation amount of an inner peripheral surface (diameter variation amount) between the bearing sleeve prior to fixation to a housing and the bearing sleeve after fixation to the housing. In the research, the housing and the bearing sleeve were fixed to each other by what is called gap-filling bonding performed by interposing an adhesive in a gap between the housing and the bearing sleeve loosely fitted to each other. Five samples were prepared for each of four types of bearing sleeves having Young's moduli of 40 GPa, 70 GPa, 100 GPa, and 200 GPa. A density of each of the samples was set to 88%.

As a result, a graph as shown in FIG. 1 was obtained. The ordinate axis of this graph represents dimensional variation amounts of inner diameters of the samples before and after fixation of the samples to the housing (average value measured at three points), and the abscissa axis represents the Young's moduli of the samples. The difference in dimensional variation amount of the inner diameters of the samples having the same Young's modulus fell within a range of ±0.05 μm, and hence is represented by one plot. In the case of the small-diameter shaft having the outer diameter of from 2 mm to 4 mm, the bearing sleeve can be practically used as long as the dimensional variation amounts of the inner diameters are equal to or less than 0.5 μm. In view of this, the objective was set to reliably suppress the dimensional variation amounts of the inner diameters to be equal to or less than 0.5 μm. The graph of FIG. 1 shows that, when the Young's modulus is equal to or more than 70 GPa, the dimensional variation amounts of the inner diameters are approximately equal to or less than 0.4 μm, and fall within a range of 0.5 μm or less even in consideration of a safety factor. Further, a slope of a curve in the graph largely changes at a point of 70 GPa. Ina region of 70 GPa or more, the slope is significantly gentle, and the dimensional variation amounts of the inner diameters are substantially constant. Those facts prove that, by setting the Young's modulus of the bearing sleeve to be equal to or more than 70 GPa, the dimensional variation amount of the inner diameter of the bearing sleeve can be reliably suppressed to be equal to or less than 0.5 μm. As a result, a fluid dynamic bearing device suitable for supporting small-diameter shafts can be obtained.

The Young's modulus can be measured by a method conforming to JPMA M 10-1997, or indirectly estimated by measurement of radial crushing strength of the bearing sleeve. The radial crushing strength can be measured by a method conforming to JIS Z2507. For example, when the radial crushing strength is equal to or more than 600 N/mm², the Young's modulus can be estimated to be equal to or more than 70 GPa.

When the housing is made of a metal, the dimensional variation of the inner peripheral surface of the bearing sleeve may become significant. In other words, the housing made of a metal generally has high rigidity, and hence high resistance against the bearing sleeve is applied from the housing, for example, when the bearing sleeve is fixed to an inner periphery of the housing by press-fitting. As a result, a risk of deformation increases. Further, the housing made of a metal generally has a large linear expansion coefficient, and hence is liable to expand and shrink by a change in temperature. As a result, pressure is applied to the bearing sleeve, and the risk of deformation increases. Therefore, the present invention is suitably applied to use of the housing made of a metal.

On the inner peripheral surface of the bearing sleeve, it is possible to form a dynamic pressure generating portion for actively generating a dynamic pressure action onto the fluid film in the radial bearing gap. The dynamic pressure generating portion can be formed, for example, by a pressing process with a molding die.

A material containing, for example, one or both of Cu and an Fe-based metal can be used as a material for the bearing sleeve. When the material for the bearing sleeve contains both of Cu and the Fe-based metal, a formulation rate of the Fe-based metal can be set to be higher than a formulation rate of Cu.

When a sintering temperature of the bearing sleeve is excessively low, surfaces of metal powder particles are not sufficiently activated, which may lead to a risk that bondability of the metal powder particles becomes deficient. Thus, it is preferred to set the sintering temperature to be equal to or more than 750° C. Meanwhile, in a case where a sintered material contains Cu, when the sintering temperature exceeds the melting point of Cu, Cu contained in the metal powder is perfectly molten, with the result that a shape of the bearing sleeve cannot be maintained. Therefore, it is preferred to set the sintering temperature to be equal to or more than 750° C. and equal to or lower than the melting point of Cu.

### Advantageous Effects of Invention

As described above, according to the present invention, dimensional variation of the inner peripheral surface of the bearing sleeve can be suppressed. Thus, a fluid dynamic bearing device having high radial supportability can be obtained.

### BRIEF DESCRIPTION OF DRAWINGS

FIG. 1 A graph showing a relationship between Young's moduli and dimensional variation amounts of inner diameters of samples of a bearing sleeve.

FIG. 2 A sectional view of a spindle motor.

FIG. 3 An axial sectional view of a fluid dynamic bearing device.

FIG. 4 An axial sectional view of the bearing sleeve.

FIG. 5 A bottom view of the bearing sleeve.

FIG. 6a A sectional view illustrating a procedure for fixing a housing and the bearing sleeve to each other (prior to heating).

FIG. 6b Another sectional view illustrating the procedure for fixing the housing and the bearing sleeve to each other (during heating (adhesive curing)).

FIG. 6c Still another sectional view illustrating the procedure for fixing the housing and the bearing sleeve to each other (during cooling).

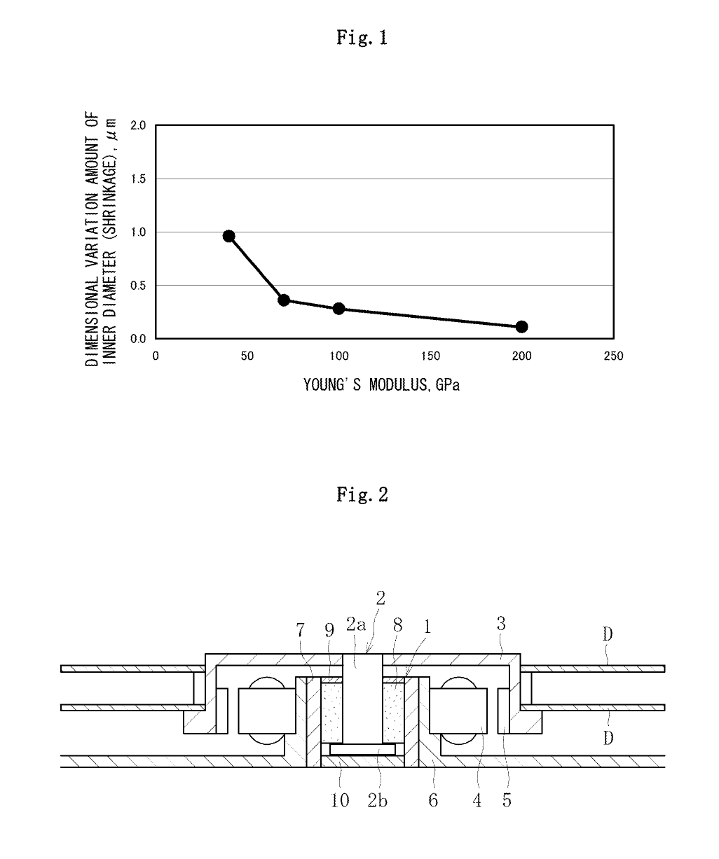

### DESCRIPTION OF EMBODIMENT

In the following, description is made of an embodiment of the present invention with reference to the drawings.

FIG. 2 illustrates a structural example of a spindle motor for information apparatus, which incorporates a fluid dynamic bearing device 1 according to the embodiment of the present invention. This spindle motor is used for disk drive devices of, for example, a 2.5-inch HDD, and includes the fluid dynamic bearing device 1 for rotatably supporting a shaft member 2 in a non-contact manner, a disk hub 3 mounted to the shaft member 2, a bracket 6 to which the fluid dynamic bearing device 1 is fixed, and stator coils 4 and rotor magnets 5 facing each other across a radial gap. The stator coils 4 are fixed to the bracket 6, and the rotor magnets 5 are fixed to the disk hub 3. The disk hub 3 holds a predetermined number of disks D (two disks in FIG. 2) such as a magnetic disk. When the stator coils 4 are energized, the rotor magnets 5 are relatively rotated by an electromagnetic force between the stator coils 4 and the rotor magnets 5. With this, the disk hub 3, the disks D, and the shaft member 2 are rotated integrally with each other.

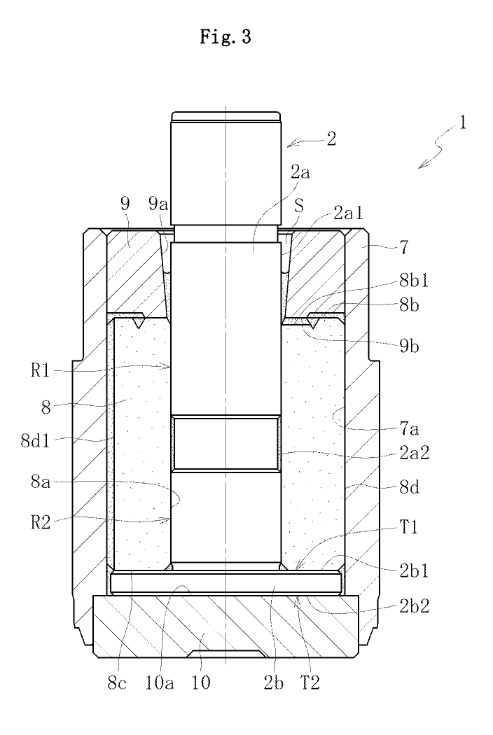

As illustrated in FIG. 3, the fluid dynamic bearing device 1 is formed of the shaft member 2, a bearing sleeve 8 having an inner periphery on which the shaft member 2 is inserted, a housing 7 having a cylindrical shape opened on both axial sides thereof and having an inner peripheral surface 7a to which the bearing sleeve 8 is fixed, a sealing portion 9 provided at one axial opening portion of the housing 7, and a lid member 10 for closing another axial opening portion of the housing 7. Note that, for the sake of convenience of description, the following description is made on the premise that a side on which the housing 7 is opened in the axial direction is referred to as an upper side, and a side on which the housing 7 is closed by the lid member 10 is referred to as a lower side.

The shaft member 2 is made of a metal material such as a stainless steel, and includes a shaft portion 2a having an outer diameter (diameter) of from 2 mm to 4 mm, and a flange portion 2b provided at a lower end of the shaft portion 2a. In an outer peripheral surface 2a1 of the shaft portion 2a, there is formed a relief portion 2a2 radially smaller relative to other parts. The shaft member 2 may be entirely made of a metal, or may have a hybrid structure of a metal and a resin, which is obtained, for example, by forming apart (for example, both end surfaces) or the entirety of the flange portion 2b with a resin.

The bearing sleeve 8 is made of a sintered metal obtained by sintering a compact formed by compressing a metal powder. A material for the bearing sleeve 8 contains, for example, one or both of Cu and an Fe-based metal. The bearing sleeve 8 in this embodiment is made of a material containing Cu and SUS (stainless steel), and a formulation rate of SUS is higher than that of Cu. When the material for the bearing sleeve 8 contains SUS as described above, SUS can be exposed on bearing surfaces (inner peripheral surface 8a and lower end surface 8c). With this, abrasion resistance of the bearing sleeve 8 against sliding with respect to the shaft member 2 can be increased.

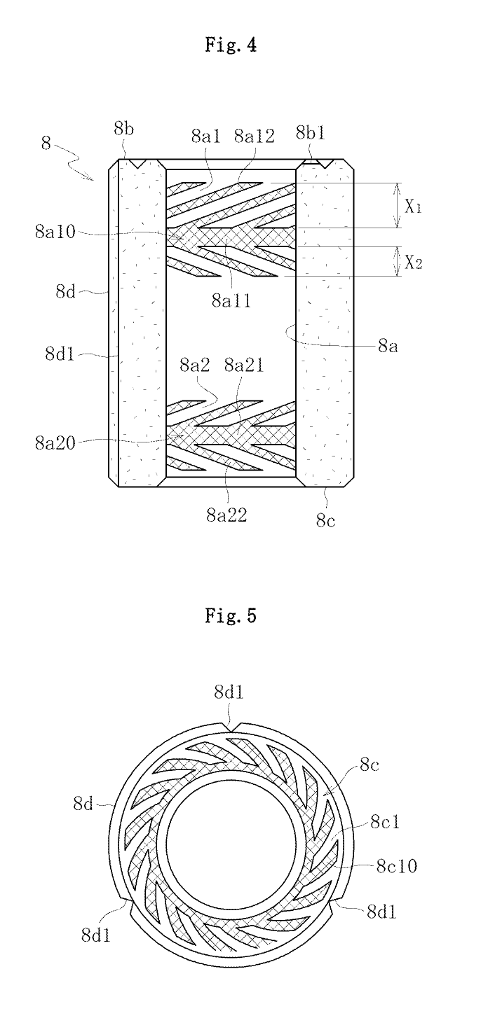

On the inner peripheral surface 8a of the bearing sleeve 8, there are formed radial dynamic pressure generating portions for actively generating a dynamic pressure action onto fluid films in radial bearing gaps. In this embodiment, as illustrated in FIG. 4, herringbone dynamic pressure generating grooves 8a1 and 8a2 are formed as the radial dynamic pressure generating portions in two regions spaced apart from each other in the axial direction. Specifically, in the two regions of the inner peripheral surface 8a of the bearing sleeve 8, which are spaced apart from each other in the axial direction, there are formed herringbone hill portions 8a10 and 8a20 (indicated by cross-hatching in FIG. 4) slightly projecting radially inward. The hill portions 8a10 and 8a20 are respectively formed of annular portions 8a11 and 8a21 formed at substantially axially central portions of the hill portions 8a10 and 8a20 and inclined portions 8a12 and 8a22 extending from the annular portions 8a11 and 8a21 to both axial sides thereof, and the dynamic pressure generating grooves 8a1 and 8a2 are respectively formed in a radial direction among the inclined portions 8a12 and 8a22. In this embodiment, the dynamic pressure generating grooves 8a1 on the upper side are formed asymmetrically in the axial direction for the purpose of intentionally generating circulation of a lubricating oil inside the bearing. Specifically, an axial dimension X₁ of an upper region with respect to the annular portion 8a11 of the hill portion 8a10 of the dynamic pressure generating grooves 8a1 is set to be larger than an axial dimension X₂ of a lower region with respect to the annular portion 8a11. Meanwhile, the dynamic pressure generating grooves 8a2 on the lower side are formed symmetrically in the axial direction.

In the lower end surface 8c of the bearing sleeve 8, as a thrust dynamic pressure generating portion, for example, there are formed spiral dynamic pressure generating grooves 8c1 as illustrated in FIG. 5. Specifically, on the lower end surface 8c of the bearing sleeve 8, there are formed spiral hill portions 8c10 slightly projecting downward, and the dynamic pressure generating grooves 8c1 are formed among the hill portions 8c10.

As illustrated in FIGS. 4 and 5, in an outer peripheral surface 8d of the bearing sleeve 8, there are formed an arbitrary number of (for example, three) axial grooves 8d1 over the entire axial length of the bearing sleeve 8, and in an upper end surface 8b of the bearing sleeve 8, there are formed an arbitrary number of (for example, three) radial grooves 8b1. In an assembled state of the fluid dynamic bearing device 1, as illustrated in FIG. 3, the axial grooves 8d1 and the radial grooves 8b1 of the bearing sleeve 8 form a part of a circulation path for circulating the lubricating oil inside the bearing.

A density of the bearing sleeve 8 is set within a range of from 80% to 95%, and a Young's modulus of the bearing sleeve 8 is set to be equal to or more than 70 GPa. With this, dimensional variation of an inner diameter of the bearing sleeve 8 can be suppressed, and hence gap widths of the radial bearing gaps can be set with high accuracy, and high radial supportability can be obtained.

Further, when the Young's modulus of the bearing sleeve 8 is excessively high, there is a risk that moldability of the bearing sleeve 8 is deteriorated and desired dimensional accuracy cannot be obtained. In particular, as described above, in a case where the dynamic pressure generating portions (dynamic pressure generating grooves 8a1, 8a2, and 8c1) are provided to the bearing sleeve 8, when the Young's modulus is set to be unnecessarily high, molding accuracy of the dynamic pressure generating portions may be deteriorated and the dynamic pressure action may be weakened. Thus, it is preferred to set the Young's modulus to be equal to or less than 150 GPa (approximately equal to or less than 1,500 N/mm² in terms of radial crushing strength).

As illustrated in FIG. 3, the housing 7 has a cylindrical shape opened on both the axial sides thereof, and made of, for example, a metal material. In this embodiment, the housing 7 is made of brass. Note that, the housing 7 is not necessarily made of a metal material, and may be made of a resin material. To the inner peripheral surface 7a of the housing 7, the outer peripheral surface 8d of the bearing sleeve 8 is fixed by appropriate means such as gap-filling bonding, press-fitting, and press-fit bonding. In this embodiment, fixation by gap-filling bonding is performed.

The lid member 10 is made, for example, of a metal material, and fixed to a lower-end opening portion of the housing 7 by appropriate means such as bonding, press-fitting, press-fit bonding, and welding. In an upper end surface 10a of the lid member 10, for example, spiral dynamic pressure generating grooves (not shown) are formed as a dynamic pressure generating portion.

The sealing portion 9 is obtained, for example, by forming a resin material into an annular shape, and fixed to an upper end portion of the inner peripheral surface 7a of the housing 7 by appropriate means such as bonding, press-fitting, press-fit bonding, and welding. A lower surface 9b of the sealing portion 9 is in abutment against the upper end surface 8b of the bearing sleeve 8. An inner peripheral surface 9a of the sealing portion 9 is formed into a tapered shape in which its diameter gradually decreases downward. Between the tapered inner peripheral surface 9a and the cylindrical outer peripheral surface 2a1 of the shaft portion 2a, there is formed a wedge-like seal space S gradually decreasing downward in radial dimension. As a result, there is formed a capillary seal which retains the lubricating oil with a capillary force of the seal space S. A capacity of the seal space S is set to be larger than a thermal expansion amount of the lubricating oil retained inside the bearing device within an operating temperature range of the bearing device. With this, within the operating temperature range of the bearing device, the lubricating oil does not leak from the seal space S, and an oil level of the lubricating oil is constantly maintained within the seal space S.

When the shaft member 2 is rotated, the radial bearing gaps are formed between the inner peripheral surface 8a of the bearing sleeve 8 and the outer peripheral surface 2a1 of the shaft member 2. Then, the radial dynamic pressure generating portions (dynamic pressure generating grooves 8a1 and 8a2 of the inner peripheral surface 8a of the bearing sleeve 8, refer to FIG. 4) increase pressure of the fluid films (oil films) formed in the radial bearing gaps. By such a dynamic pressure action, there are formed radial bearing portions R1 and R2 for rotatably supporting the shaft portion 2a of the shaft member 2 in the radial direction in a non-contact manner (refer to FIG. 3).

Simultaneously, thrust bearing gaps are formed respectively between the lower end surface 8c of the bearing sleeve 8 and an upper end surface 2b1 of the flange portion 2b of the shaft member 2 and between the upper end surface 10a of the lid member 10 and a lower end surface 2b2 of the flange portion 2b of the shaft member. Then, the thrust dynamic pressure generating portions (dynamic pressure generating grooves 8c1 of the lower end surface 8c of the bearing sleeve 8 (refer to FIG. 5), and dynamic pressure generating grooves of the upper end surface 10a of the lid member 10) increase pressure of fluid films (oil films) formed in the thrust bearing gaps. By such a dynamic pressure action, there are formed a first thrust-bearing portion T1 and a second thrust-bearing portion T2 for rotatably supporting the flange portion 2b of the shaft member 2 in both thrust directions in a non-contact manner (refer to FIG. 3).

In the following, description of manufacturing steps for the fluid dynamic bearing device 1 is made with a focus on manufacturing steps for the bearing sleeve 8 and assembly steps for the bearing sleeve 8 and the housing 7.

The bearing sleeve 8 is manufactured through a compression-molding step, a sintering step, and a sizing step. The compression-molding step is performed by compression-molding, with a die, a mixed metal powder to be used as a material for the bearing sleeve. The mixed metal powder contains, for example, a Cu powder, a Cu—Fe alloy powder, an Fe-based metal powder, and the like. The mixed metal powder used in this embodiment contains a Cu powder and an SUS powder. As described above, when the mixed metal powder contains a Cu powder, which is relatively soft, moldability in the compression-molding step and the sizing step described below can be enhanced.

In the sintering step, a compact molded by the compression-molding step is sintered at a predetermined temperature. The sintering temperature at this time is set to a temperature at which metal powder particles can be bonded to each other, specifically, to be equal to or more than 750° C. In particular, as in this embodiment, when the metal powder forming the bearing sleeve 8 contains an SUS powder, sintering bondability of the metal powder particles may become deficient owing to oxide films on SUS powder particles. Thus, it is preferred to perform sintering at a temperature as high as possible (for example, equal to or more than 950° C.). Meanwhile, when the sintering temperature exceeds a melting point of the metal powder, the shape of the bearing sleeve 8 cannot be maintained. Thus, it is necessary to set the sintering temperature to be equal to or lower than the melting point of the metal powder. In this embodiment, it is necessary to set the sintering temperature to be equal to or lower than the melting point of Cu (1,084° C.).

In the sizing step, the compact having undergone the sintering step (hereinafter, referred to as sintered compact) is corrected with a sizing die so as to have predetermined dimensions. The sizing die is provided with a molding die for molding the dynamic pressure generating portions (dynamic pressure generating grooves 8a1, 8a2, and 8c1) onto the bearing sleeve 8. By performing a pressing process with the molding die simultaneously with sizing, sizing of the sintered compact and molding of the dynamic pressure generating portions are performed within the same step.

The bearing sleeve 8 formed as described above has a density within a range of from 80% to 95%, and a Young's modulus equal to or more than 70 GPa. In other words, those conditions are satisfied by appropriately setting parameters such as grain sizes of the metal powder, a compression rate in the compression-molding step, the sintering temperature and a sintering time period in the sintering step, and a compression rate in the sizing step.

The bearing sleeve 8 formed as described above is fixed to the inner peripheral surface 7a of the housing 7. In this embodiment, the bearing sleeve 8 and the inner peripheral surface 7a of the housing 7 are fixed to each other by gap-filling bonding, in particular, gap-filling bonding with use of a thermosetting adhesive. Specifically, the thermosetting adhesive is applied onto the inner peripheral surface 7a of the housing 7, and the bearing sleeve 8 is inserted along an inner periphery of the housing 7. Then, the bearing sleeve 8 is aligned to a predetermined position on the inner peripheral surface 7a of the housing 7. In this state, the housing 7 and the bearing sleeve 8 are collectively heated so as to cure the adhesive. After that, the housing 7 and the bearing sleeve 8 are cooled to a room temperature. In this way, fixation is completed.

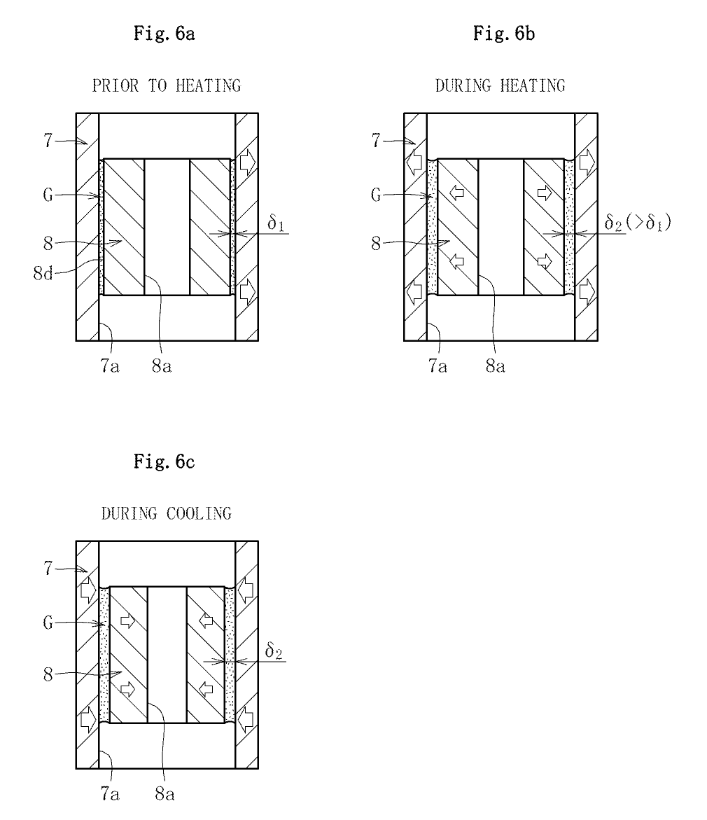

In the step of fixing the housing 7 and the bearing sleeve 8 to each other, heating for curing the thermosetting adhesive may cause the following failure. Specifically, as illustrated in FIG. 6a, when heating is performed under a state in which a thermosetting adhesive G is interposed in a radial gap δ₁ between the inner peripheral surface 7a of the housing 7 and the outer peripheral surface 8d of the bearing sleeve 8, both the housing 7 and the bearing sleeve 8 undergo thermal expansion. In particular, as in this embodiment, when the housing 7 is made of brass and the bearing sleeve 8 is made of the sintered metal containing Cu and SUS, a linear expansion coefficient of the housing 7 is larger than a linear expansion coefficient of the bearing sleeve 8. Specifically, the linear expansion coefficient of brass is approximately 19×10⁻⁶/° C., whereas the linear expansion coefficient of the sintered metal made of the above-mentioned materials is approximately 13×10⁻⁶/° C. Due to such a difference in linear expansion coefficient, heating causes a radial gap δ₁ between the housing 7 and the bearing sleeve 8 prior to heating to become the larger gap δ₂ (δ₂>δ₁, refer to FIG. 6b). In this state, the thermosetting adhesive G interposed in the radial gap δ₂ is cured.

Subsequently, when the housing 7 and the bearing sleeve 8 are cooled, as illustrated in FIG. 6c, the diameter of the inner peripheral surface 7a decreases in accordance with thermal shrinkage of the housing 7. At this time, the adhesive G has already been cured, and hence the size of the radial gap δ₂ remains the same. In addition, owing to the decrease in diameter of the inner peripheral surface 7a of the housing 7, the bearing sleeve 8 is compressed radially inward through intermediation of the cured adhesive G. In particular, when the housing 7 is made of a metal material (brass) as in this embodiment, the Young's modulus of the housing 7 is relatively high (approximately 100 GPa), and hence a compressive force acting onto the bearing sleeve 8 as a result of shrinkage of the housing 7 is relatively high. According to the present invention, as described above, the bearing sleeve 8 has the density increased to be equal to or more than 80% and the Young's modulus equal to or more than 70 GPa. Thus, the bearing sleeve 8 has a sufficient strength against such a compressive force, and hence deformation of the bearing sleeve 8, in particular, deformation of the inner peripheral surface 8a can be suppressed.

Here, description is made of a case where the housing 7 and the bearing sleeve 8 are fixed to each other with a thermosetting adhesive. In addition, also when the housing 7 and the bearing sleeve 8 are fixed to each other by other fixing methods such as fixation by press-fitting, the inner peripheral surface 8a of the bearing sleeve 8 may be deformed. Thus, as described above, it is effective to enhance the density and the Young's modulus of the bearing sleeve 8.

Further, as in this embodiment, when the fluid dynamic bearing device is used in a spindle motor for disk drive devices of an HDD and the like, the shaft member 2 is rotated at ultra-high speed, and hence markedly high pressure is generated in the fluid films between the shaft member 2 and the bearing sleeve 8. When such pressure of the fluid films is applied to the bearing sleeve 8, the bearing sleeve 8 undergoes minute elastic deformation, which may generate vibration in the rotating shaft member 2. As described above, when the Young's modulus of the bearing sleeve 8 is equal to or more than 70 GPa, the minute deformation of the bearing sleeve 8 can be suppressed and the vibration of the shaft member 2 can be prevented, which are caused by the pressure of the fluid films.

The present invention is not limited to the above-mentioned embodiment. For example, in the above-mentioned embodiment, the bearing sleeve 8 is provided with the dynamic pressure generating portions formed of the herringbone or spiral dynamic pressure generating grooves, but the present invention is not limited thereto. The dynamic pressure generating portions may be formed as follows: forming dynamic pressure generating grooves having other shapes; or forming the inner peripheral surface 8a of the bearing sleeve 8 into a multi-arc shape obtained by combining a plurality of circular arcs. Alternatively, the dynamic pressure generating portions may be provided not to the inner peripheral surface 8a and the lower end surface 8c of the bearing sleeve 8 but to a member facing those surfaces across the bearing gaps (outer peripheral surface 2a1 of the shaft portion 2a and the upper end surface 2b1 of the flange portion 2b of the shaft member 2). Still alternatively, what is called a cylindrical bearing may be formed, in which both the inner peripheral surface 8a of the bearing sleeve 8 and the outer peripheral surface 2a1 of the shaft portion 2a of the shaft member 2 are formed as cylindrical surfaces. In this case, the dynamic pressure generating portions for actively generating the dynamic pressure action are not formed, but still the dynamic pressure action is generated by slight centrifugal whirling of the shaft portion 2a.

Further, in the above-mentioned embodiment, the fluid dynamic bearing device of the present invention is applied to the spindle motor for the disk drive devices of an HDD. However, the present invention is not limited thereto, and can be effectively applied to other uses for supporting relative rotation of a shaft member having an outer diameter of from 2 mm to 4 mm.

### REFERENCE SIGNS LIST

1 fluid dynamic bearing device
2 shaft member
3 disk hub
4 stator coil
5 rotor magnet
6 bracket
7 housing
8 bearing sleeve
9 sealing portion
10 lid member
D disk
R1•R2 radial bearing portion
T1•T2 thrust-bearing portion
S seal space

1. A fluid dynamic bearing device, comprising:
a shaft member having an outer diameter of from 2 mm to 4 mm;
a bearing sleeve made of a sintered metal and having an inner periphery on which the shaft member is inserted;
a housing having an inner peripheral surface to which the bearing sleeve is fixed; and
a radial bearing portion for supporting the shaft member with a fluid film in a radial bearing gap to be formed between an outer peripheral surface of the shaft member and an inner peripheral surface of the bearing sleeve so that the shaft member is relatively rotatable,
wherein a density of the bearing sleeve falls within a range of from 80% to 95% with respect to a true density, and
wherein a Young's modulus of the bearing sleeve is equal to or more than 70 GPa.

2. A fluid dynamic bearing device according to claim 1, wherein radial crushing strength of the bearing sleeve is equal to or more than 600 N/mm2.

3. A fluid dynamic bearing device according to claim 1, wherein the housing is made of a metal.

4. A fluid dynamic bearing device according to claim 1, further comprising a dynamic pressure generating portion formed on the inner peripheral surface of the bearing sleeve.

5. A fluid dynamic bearing device according to claim 4, wherein the dynamic pressure generating portion is formed by a pressing process with a molding die.

6. A fluid dynamic bearing device according to claim 1, wherein a material for the bearing sleeve contains Cu.

7. A fluid dynamic bearing device according to claim 1, wherein the material for the bearing sleeve contains an Fe-based metal.

8. A fluid dynamic bearing device according to claim 1,
wherein a material for the bearing sleeve contains Cu and an Fe-based metal, and
wherein a formulation rate of the Fe-based metal is higher than a formulation rate of Cu.

9. A fluid dynamic bearing device according to claim 6, wherein a sintering temperature of the bearing sleeve is equal to or more than 750° C. and equal to or lower than a melting point of Cu.

10. A bearing sleeve for supporting a shaft member having an outer diameter of from 2 mm to 4 mm, the bearing sleeve being made of a sintered metal, having a density within a range of from 80% to 95% with respect to a true density, and having a Young's modulus equal to or more than 70 GPa.

11. A fluid dynamic bearing device according to claim 8, wherein a sintering temperature of the bearing sleeve is equal to or more than 750° C. and equal to or lower than a melting point of Cu.
